(19) United States
(12) Patent Application Publication
(10) Pub. No.: US 2004/0187798 A1
(43) Pub. Date: Sep. 30, 2004

(54) Subassembly of an internal combustion engine having a tribologically stressed component

(76) Inventors: Guenter Schneider, Besigheim (DE); Thomas Beck, Kirchberg (DE); Alexander Schattke, Stuttgart (DE); Sascha Henke, Weil der Stadt (DE)

Correspondence Address: KENYON & KENYON, ONE BROADWAY, NEW YORK, NY, 10004, US

(21) Appl. No.: 10/632,173

(22) Filed: Jul. 30, 2003

(30) Foreign Application Priority Data
Jul. 30, 2002 (DE) 102 34 588.0

(51) Int. Cl. F02F 7/00

(52) U.S. Cl. 123/1 A

(57) ABSTRACT

A subassembly of an internal combustion engine is described, in particular an injection system or a fuel injector having a tribologically stressed component, in particular an injection needle, having a surface area which moves relative to a mating body during operation and is thus tribologically stressed, the surface area having an at least mostly an inorganic hard material coating. The subassembly is suitable in particular for use in an internal combustion engine which is operated with a dry gas such as natural gas or hydrogen as the fuel or under oil-free and/or water-free combustion conditions. In addition, a gas engine having such a subassembly is described.

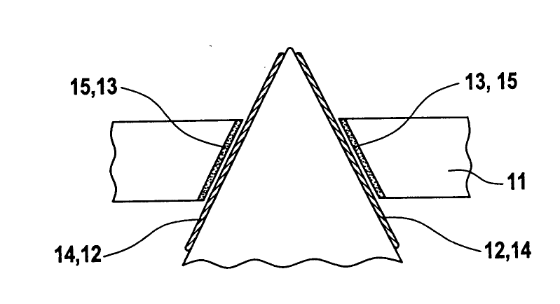

### FIELD OF THE INVENTION

The present invention relates to a subassembly of an internal combustion engine, in particular an injection system or a fuel injector having a tribologically stressed component, use thereof and a gas engine having this subassembly.

### BACKGROUND INFORMATION

Valves based on gasoline injectors are used in some gas engines. Natural gas, which has been used mostly in the past for oil-sealed compressors, contains a small amount of oil, so that the valves which have been used have a sufficiently long operating lifetime because even minute quantities of oil are sufficient for reliable operation.

In future applications, however, gas engines may be expected to be operated increasingly with oil-free compressed gases and at the same time with gases that are almost completely dried, in particular with the help of a cryogenic dryer.

Experiments with such oil-free dry gases in related art engines having gasoline injectors have shown that the operating lifetime of the valves drops from a few thousand hours, as it has been previously, to only a few hours. In particular, it has been found that valve needles seize up after only 10 to 100 hours of operating time or test time with dry nitrogen. This problem is also associated with other dry gases such as hydrogen.

To provide protection against wear of subassemblies under high tribological stress, e.g., in components of injection systems or fuel injectors, carbon-based layers, in particular DLC layers (diamond-like carbon) or iC-WC layers have been used for many years. However, these also fail when used in an absolutely dry environment, and under such conditions they do not offer any improvement in comparison with components without such a coating.

Finally, it is known that reactive sputtering or arc deposition of inorganic hard material layers as a wear-resistant coating for cutting and pressing tools results in a definite lengthening of lifetime. Known hard material layers include chromium nitride, titanium nitride, zirconium nitride, vanadium nitride, niobium nitride, titanium aluminum nitride, chromium aluminum nitride, or zirconium aluminum nitride layers, as well as combinations thereof as multilayers, e.g., in the form of titanium aluminum nitride/chromium nitride or titanium nitride/vanadium nitride and titanium nitride/niobium nitride. In addition, it is known that such hard material coatings have a high thermal stability, so they may be used for coating drills and chipping tools which may be exposed to temperatures up to 600° C. during use to increase their lifetime.

An object of the present invention was to provide a subassembly of an internal combustion engine, in particular an injection system or a fuel injector, having a tribologically stressed component which is provided with a coating such that this subassembly may also be used in an internal combustion engine operated with a dry gas fuel, in particular an oil-free gas.

### SUMMARY OF THE INVENTION

The subassembly of an internal combustion engine according to the present invention has the advantage over the related art that it has a much higher wear resistance in a dry environment and/or an oil-free environment in comparison with a carbon-based coating or a component without a coating.

In particular, it has been shown that injectors provided with an inorganic hard material coating have significantly improved lifetimes under dry and oil-free combustion conditions in an internal combustion engine in a model wear test (vibration wear) in comparison with uncoated injectors or injectors provided with a carbon-based layer (DLC layer). To do so, a subassembly according to the present invention in the form of a coated test body made of steel (100Cr6 steel) was exposed to stress from an oscillating ball, the measure of the stability of the coating being the time until its failure.

Inorganic nitride hard material coatings in particular had much better properties in this connection in comparison with conventional carbon-based layers.

As a result, the advantage of carbon-based layers in gasoline or diesel injection systems having gasoline or diesel as the ambient medium becomes a disadvantage under very dry and/or oil-free ambient conditions, i.e., when using dry, oil-free natural gas or hydrogen, i.e., applying such carbon-based layers proves to be of no benefit, whereas the desired wear prevention may be ensured in this case by the inorganic hard material coating according to the present invention.

It should be pointed out here that in lubricated contact, a film of lubrication normally separates the two friction partners, whereas under mixed friction conditions i.e., in the area of the reversal points of an oscillating movement or under extreme operating parameters, e.g., in a fuel injector, the lubricant film detaches, which results in direct solid-solid contact of the two surfaces rubbing against one another. Especially under dry operating conditions, in particular oil-free operating conditions or applications, there is no separating medium between the two surfaces rubbing against one another, so that solid-solid contact of the surfaces rubbing against one another develops and persists over the entire operating time of the subassembly. Therefore, it must be designed so that this “operating state” does not result in seizing or premature failure.

On the whole, the inorganic hard material coatings on the tribologically stressed component according to the present invention are able to at least partially assume the function of the lubricant film, which is no longer present under dry, oil-free conditions. The inorganic hard material coating thus prevents direct contact between two steel surfaces or metal surfaces and/or reduces their adhesion tendency. In addition, it reduces the coefficient of friction between the two particular surfaces and produces a type of solid-to-solid lubrication. Finally, due to the inorganic hard material coating, the chemical reactivity of the surfaces rubbing against one another, i.e., the surfaces of the mating body and the subassembly is reduced. Thus, the inorganic hard material coating provided according to the present invention on the surface area of the tribologically stressed component has the effect that this component operates under low-wear conditions even when there is no lubrication and it is absolutely dry.

It is particularly advantageous if both the mating body and the component are provided with an at least mostly inorganic hard material coating in the surface area, where the two parts are in frictional contact during operation of the component, and if these two inorganic hard material coatings preferably have the same structure and/or the same compositions.

In addition, it is often advantageous if the applied hard material coating on the component and/or on the mating body has multiple sublayers, as is customary in the related art in coating cutting or pressing tools. In this connection, it is also advantageously possible to design the hard material coating or at least a sublayer of the hard material coating as a layer having a homogeneous, graduated or structured material composition.

To produce the inorganic hard material coating on the component or the mating body, a PVD method or a PECVD method such as those known in various embodiments in the related art is particularly suitable.

It is most particularly advantageous if the inorganic hard material coating on the component and/or the mating body has a nanostructured layer, in particular a layer having nanocrystalline titanium nitride embedded in a matrix of amorphous silicon nitride.

The subassembly of the internal combustion engine is suitable in particular for use in a fuel injector or an injection system which is exposed to alternative gaseous and dry fuels such as natural gas or hydrogen. The component or the mating body is preferably an intake valve, a sealing seat, a guide area of an injection needle, or a seat area of an injection needle of an injection system or a fuel injector.

### BRIEF DESCRIPTION OF THE DRAWING

The FIGURE shows a section through a basic diagram of a front part of an injection needle in the area of a nozzle orifice.

### DETAILED DESCRIPTION

The present invention is explained on the example of an injection nozzle in which an injection needle moves relative to the nozzle.

The FIGURE shows a front part of this injection needle as tribologically stressed component 10, moving in a mating body 11, i.e., a seat for the injection needle in the example explained here. Then under dry, oil-free combustion conditions in an internal combustion engine equipped with an injection system and/or an injector having the subassemblies according to the FIGURE, unlubricated solid-solid contact occurs in a surface area 12 of component 10 with respect to a surface area 13 of mating body 11. The subassembly according to the FIGURE is in particular part of a gas engine such as a natural gas engine or a hydrogen engine and is in turn part of an injection system or an injector of this engine.

The FIGURE also shows how an at least mostly inorganic hard material coating 14 is applied in surface area 12 of tribologically stressed component 10. In addition, a corresponding, at least largely inorganic, hard material coating 15 is also applied to surface area 13 of mating body 11. To this extent, surface area 13 of mating body 11 and surface area 12 of component 10 are in frictional contact during operation, resulting in unlubricated solid-solid contact.

The thickness of inorganic hard material coatings 14, 15 of component 10 and/or mating body 11 is preferably between 0.5 μm and 5 μm, in particular 1 μm to 3 μm.

Specifically, inorganic hard material coatings 14, 15 according to the FIGURE contain or are composed of hard material coatings deposited by a PVD method (physical vapor deposition) or a PECVD method (physically enhanced chemical vapor deposition) having or containing a carbon nitridic, nitridic, oxynitridic or oxidic layer or several such sublayers.

Hard material coating 14 of component 10 and hard material coating 15 of mating body 11 are preferably a layer selected from the group of CrN, TiN, ZrN, VN, NbN, TiAlN, CrAlN or ZrAlN or a combination of such layers to yield a multilayer coating, in particular of the form or with the layer sequence TiN/VN or TiN/NbN.

In addition, hard material coating 14, 15 of component 10 and/or mating body 11 or a sublayer of hard material coating 14, 15 may also be a nanostructured layer, in particular a layer having nanocrystalline titanium nitride embedded in a matrix of amorphous silicon nitride.

Finally, to achieve a wear prevention effect optimized for the particular application, a combination layer or an alloy layer having various layer systems explained above or nanostructured layers may also be provided, these layers or sublayers being homogeneous, nonhomogeneous, graduated or structured in their material composition and properties as needed.

As shown in the FIGURE, in particular the guide area of an injection needle is provided with inorganic hard material coating 14, 15. In addition, however, this seat area of an injection needle may also be coated accordingly, e.g., to prevent an injection quantity from striking it.

Comparative tests have been conducted to verify the improved properties of the subassembly of an internal combustion engine under dry, oil-free conditions.

To do so, a test body made of steel (10Cr6) was provided with a coating and then subjected to a stress from an oscillating ball. The load (normal force) amounted to 10 Newtons, the oscillation amplitude was 200 μm, the oscillation frequency 40 Hz, the ambient temperature 50° C., the test time one hour and the thickness of the coating applied to the test body 2 μm. Dry nitrogen having a residual moisture content of less than 1% was used as the ambient medium.

A coating of diamond-like carbon (DLC layer) failed after approx. 10 minutes under these conditions.

An inorganic hard material coating of titanium nitride showed only 0.2 μm wear on the layer in this test.

In the case of an inorganic hard material coating in the form of a multiple layer having a layer sequence CrN/TiAlN, a wear of 0.3 μm was observed on the layer in this test.

A hard material coating having nanoscale titanium nitride embedded in a matrix of inorganic silicon nitride also had wear of 0.3 μm under these conditions.

What is claimed is:

1. A subassembly of an internal combustion engine, comprising:
a mating body; and
a tribologically stressed component having a surface area provided with a coating and that in operation, moves in relation to the mating body and is thereby tribologically stressed, wherein the coating is an at least mostly inorganic hard material coating.

2. The subassembly as recited in claim 1, wherein a surface area of the mating body and the surface area of the tribologically stressed component are in frictional contact during operation.

3. The subassembly as recited in claim 1, wherein a surface of the mating body is provided with another at least mostly inorganic hard material coating that has a same structure and a same composition as the at least mostly inorganic hard material coating on the surface area of the tribologically stressed component.

4. The subassembly as recited in claim 1, wherein a solid-solid contact occurs between a surface area of the mating body and the surface area of the tribologically stressed component during operation.

5. The subassembly as recited in claim 4, wherein the solid-solid contact occurs without lubrication.

6. The subassembly as recited in claim 3, wherein at least one of the at least mostly inorganic hard material coating on the tribologically stressed component and the other at least mostly inorganic hard material coating on the mating body includes several sublayers.

7. The subassembly as recited in claim 3, wherein the at least one of the at least mostly inorganic hard material coating and the other at least mostly inorganic hard material coating includes at least one of CrN, TiN, ZrN, VN, NbN, TiAlN, and CrAlN, to form a multiple layer.

8. The subassembly as recited in claim 7, wherein the multiple layer includes a layer sequence corresponding to one of TiN/VN and TiN/NbN.

9. The subassembly as recited in claim 3, wherein at least one of the at least mostly inorganic hard material coating and the other at least mostly inorganic hard material coating includes one of a carbonitridic layer, a nitridic layer, an oxinitridic layer, and an oxidic layer.

10. The subassembly as recited in claim 9, wherein the at least one of the at least mostly inorganic hard material coating and the other at least mostly inorganic hard material coating is produced by one of a PVD operation and a PECVD operation.

11. The subassembly as recited in claim 3, wherein at least one of the at least mostly inorganic hard material coating and the other at least mostly inorganic hard material coating includes a nanostructured layer.

12. The subassembly as recited in claim 11, wherein the nanostructured layer includes nanocrystalline TiN embedded in a matrix of amorphous silicon nitride.

13. The subassembly as recited in claim 3, wherein at least one of the at least mostly inorganic hard material coating and the other at least mostly inorganic hard material coating has a thickness of 0.5 μm to 5 μm.

14. The subassembly as recited in claim 3, wherein at least one of the at least mostly inorganic hard material coating and the other at least mostly inorganic hard material coating has a thickness of 1 μm to 3 μm.

15. The subassembly as recited in claim 1, wherein one of the tribologically stressed component and the mating body includes one of an intake valve, a sealing seat, a guide area of an injection needle, and a seat area of the injection needle of one of an injection system and a fuel injector.

16. A method of using a subassembly of an internal combustion engine that includes a mating body and a tribologically stressed component having a surface area provided with a coating and that in operation, moves in relation to the mating body and is thereby tribologically stressed, wherein the coating is an at least mostly inorganic hard material coating, the method comprising:
using the internal combustion engine operated with one of a dry gas such as natural gas and hydrogen as a fuel or under at least one of oil-free conditions and water-free combustion conditions.

17. A gas engine, comprising:
a subassembly including a mating body; and
a tribologically stressed component having a surface area provided with a coating and that in operation, moves in relation to the mating body and is thereby tribologically stressed, wherein the coating is an at least mostly inorganic hard material coating.

18. The gas engine as recited in claim 17, wherein the gas engine includes one of a natural gas engine and a hydrogen engine.
